(19) United States
(12) Patent Application Publication
(10) Pub. No.: US 2012/0127095 A1
(43) Pub. Date: May 24, 2012

(54) FLAT PANEL DISPLAY WITH AN INTEGRATED TOUCH SCREEN PANEL

(76) Inventor: Woo-Sik Jun, Yongin-city (KR)

(21) Appl. No.: 13/106,722

(22) Filed: May 12, 2011

(30) Foreign Application Priority Data
Nov. 23, 2010 (KR) 10-2010-0116851

(51) Int. Cl. G06F 3/041

(52) U.S. Cl. 345/173

(57) ABSTRACT

A flat panel display with an integrated touch screen panel according to an embodiment of the present invention includes: an upper substrate and a lower substrate; a plurality of sensing patterns in a display region of the upper substrate facing the lower substrate; a plurality of sensing lines coupled with the sensing patterns, respectively, in a first non-display region of the upper substrate; a sensing pad unit including a plurality of sensing pads coupled with the sensing lines, at a second non-display region of the upper substrate; a sealant between the upper substrate and a second non-display region of the lower substrate; seal patterns protruding from and perpendicular to the sealant in a region overlapping the sensing pads, the seal patterns being between the sensing pads; and a plurality of metal patterns at the second non-display region of the lower substrate overlapping the regions between the seal patterns.

### CROSS-REFERENCE TO RELATED APPLICATION

This application claims priority to and the benefit of Korean Patent Application No. 10-2010-0116851, filed on Nov. 23, 2010, in the Korean Intellectual Property Office, the entire content of which is incorporated herein by reference.

### BACKGROUND

1. Field

Aspects of embodiments according to the present invention relate to a flat panel display, particularly, a flat panel display with an integrated touch screen panel.

2. Description of Related Art

Touch screen panels are input devices that can be used to select contents displayed on the screen of an image display device, etc., with a person's hand or an object to input commands of a user.

To this end, the touch screen panels are provided on a front face of the image display device and convert positions where a person's hand or an object directly contacts into electrical signals. Accordingly, the instruction selected at the contact point is received as an input signal.

As the touch screen panels can replace separate input devices, such as a keyboard and a mouse, that are operated by being connected with the image display device, the application of the touch screen panels is being expanded gradually.

Types of the touch screen panel include an ohmic layer type, a photosensitive type, and an electrostatic type. A electrostatic type of touch screen panel converts a contact position into an electrical signal by a conductive sensing pattern that senses a change in electrostatic capacitance formed with another sensing pattern or a grounding electrode, when a person's hand or an object contacts the touch screen panel.

The touch screen panel is usually separately manufactured and attached to the outside of the display panel of a flat panel display, such as a liquid crystal display and an organic light emitting display.

However, when a touch screen panel separately manufactured is attached to the outside of the display panel of a flat panel display, the entire thickness of the flat panel display increases, the manufacturing cost also increases, and visibility of an image is reduced by a gap between the touch screen panel and the display panel.

Further, in this case, separate driving ICs for the display panel and the touch screen panel are used, such that compatibility between products may be reduced, and an individual FPCB may be connected with each of the display panel and the touch screen panel, such that the manufacturing process is complicated and the unit cost of a product increases.

### SUMMARY

Aspects of embodiments according to the present invention are directed toward a flat panel display with an integrated touch screen panel that has a reduced thickness and improved visibility of an image by using the upper substrate of a display panel as a substrate for a touch screen panel, and has a simplified manufacturing process and a reduced unit cost by coupling a touch screen panel and a display panel to one flexible printed circuit board.

A flat panel display with an integrated touch screen panel according to an embodiment of the present invention includes: an upper substrate and a lower substrate each including a display region and first and second non-display regions around the display region; a plurality of sensing patterns at the display region of the upper substrate facing the lower substrate; a plurality of sensing lines coupled with the sensing patterns, respectively, in the first non-display region of the upper substrate; a sensing pad unit including a plurality of sensing pads coupled with the sensing lines, in the second non-display region of the upper substrate; a sealant between the upper substrate and the second non-display region of the lower substrate; seal patterns protruding from and perpendicular to the sealant in a region overlapping the sensing pads, the seal patterns being between the sensing pads; and a plurality of metal patterns at the second non-display region of the lower substrate overlapping the regions between the seal patterns.

Further, each of the sensing pads may include a first connecting pattern coupled with a corresponding one of the sensing lines, a transparent conductive pattern at a region overlapping the sealant, and a second connecting pattern electrically coupled with a corresponding one of the metal patterns of the lower substrate.

Further, the seal patterns may include a same material as the sealant, and may protrude integrally from the sealant or may be spaced from the sealant.

Further, a conductive paste may be at each region between the seal patterns and the sensing pads on the upper substrate and the metal patterns on the lower substrate may be electrically coupled together, respectively, by the conductive pastes.

Further, a flexible printed circuit board electrically coupled with the metal patterns may be attached to an end of the second non-display region of the lower substrate.

Further, black matrixes may be at the first and second non-display regions of the upper substrate to be arranged along a periphery of the display region.

Further, the sensing patterns may include: first sensing cells coupled to one another in a first direction in each row; first connecting lines coupling the first sensing cells in the first direction; second sensing cells coupled to one another in a second direction in each column; and second connecting lines coupling the second sensing cells in the second direction.

Further, the second sensing cells may be integrally formed with the second connecting lines and insulating layers at crossing regions of the first connecting lines and the second connecting lines may be further included.

Further, a plurality of pixels may be at the display region of the lower substrate, and a plurality of signal lines electrically coupling the pixels with pads at the second non-display region is at the first non-display region of the lower substrate, and the signal lines include a plurality of scan lines and data lines.

According to the embodiments of the present invention described above, it is possible to minimize or reduce the thickness of a flat panel display with an integrated touch screen panel and improve transmittance by reducing the number of substrates, by using the upper substrate of the flat panel display as the substrate of the touch screen panel.

Further, it is possible to improve visibility of an image, and durability and reliability of a touch screen panel by locating sensing patterns of the touch screen panel on the inner side of the upper substrate of the display panel.

Further, it is possible to simplify the manufacturing process and the unit cost of the product by coupling a touch screen panel and a display panel to one flexible printed circuit board.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a plan view showing an upper substrate of a flat panel display according to an embodiment of the present invention.

FIG. 2 is an enlarged view showing the main parts of an example of a sensing pattern shown in FIG. 1.

FIG. 3 is a cross-sectional view of a portion (I-I′) of the flat panel display of FIG. 1 according to an embodiment of the present invention.

FIGS. 4A and 4B are enlarged plan views of a sensing pad unit according to an embodiment of the present invention.

FIG. 5 is a plan view showing an upper substrate and a lower substrate of a flat panel display with an integrated touch screen panel according to an embodiment of the present invention.

FIG. 6 is a cross-sectional view of a portion (II-II′) of a sensing pad unit of FIG. 5.

FIG. 7 is a cross-sectional view of a portion in the Y-axis including the sensing pad unit of FIG. 5.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” or “coupled to” another element, it can be directly connected to the another element or be indirectly connected to the another element with one or more intervening elements interposed therebetween. Hereinafter, like reference numerals refer to like elements.

Hereinafter, embodiments of the present invention will be described in detail with reference to the accompanying drawings.

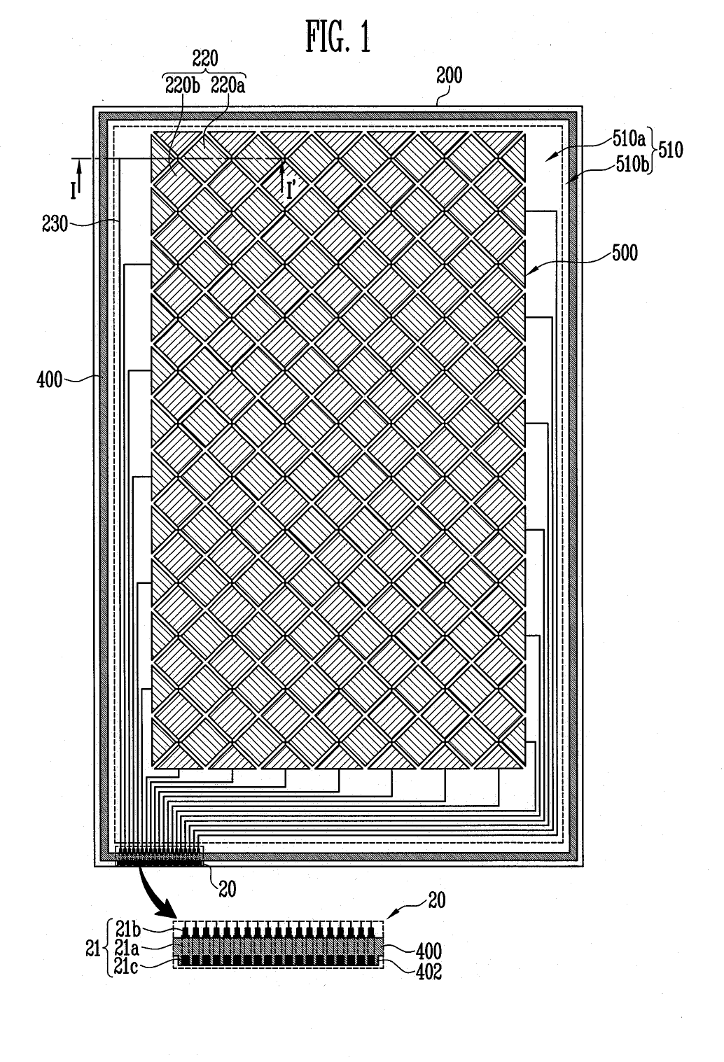

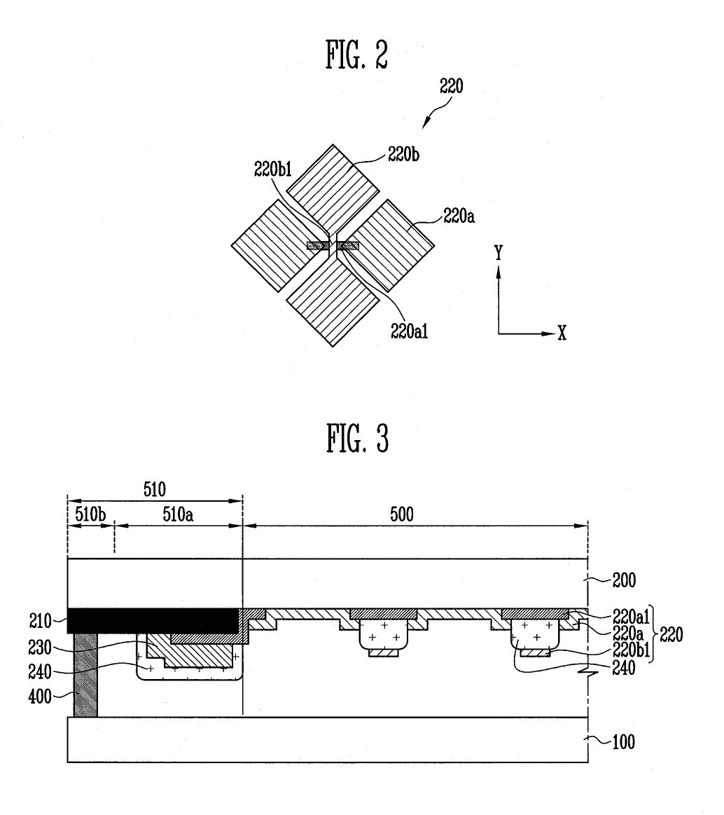

FIG. 1 is a plan view showing an upper substrate of a flat panel display according to an embodiment of the present invention, FIG. 2 is an enlarged view showing the main parts of an example of the sensing pattern shown in FIG. 1, and FIG. 3 is a cross-sectional view of a portion (I-I′) of the flat panel display of FIG. 1 according to an embodiment of the present invention.

Embodiments of the present invention are directed to a flat panel display with an integrated touch screen panel and which is characterized in that a touch screen panel according to an embodiment of the present invention is directly on aside of an upper substrate 200 of a flat panel display, referring to FIGS. 1 to 3.

In this configuration, the side of the upper substrate 200 is a surface that faces and is in contact with a lower substrate corresponding to the upper substrate, and corresponds to the inner side of the upper substrate. That is, FIG. 1 is a plan view of the inner side of the upper substrate of a flat panel display according to an embodiment of the present invention.

Further, the flat panel display may be an organic light emitting display device or a liquid crystal display device. According to an embodiment of the present invention, the upper substrate 200 is an encapsulation substrate of the organic light emitting display device and may be made of a transparent material.

Further, a touch screen panel according to an embodiment of the present invention, as shown in FIG. 1, includes sensing patterns 220 on the rear side of the upper substrate 200 and sensing lines 230 coupling the sensing patterns 220 with an external driving circuit (not shown) through a sensing pad unit 20.

In this configuration, the region with the sensing patterns 220 is a display region 500 that displays an image and detects a touch position, and the region with the sensing lines 230 electrically coupled with the sensing patterns 220 and the sensing pad unit 20 is a non-display region 510 formed around the display region 500.

Further, in an embodiment of the present invention, the non-display region 510 is divided into a first non-display region 510a with the sensing lines 230 and a second display region 510b with the sensing pad unit 20 including a plurality of sensing pads 21 coupled with the sensing lines 230, around the first non-display region 510a.

In this configuration, the second non-display region 510b is a region where a sealant 400 is applied between the upper substrate 200 and a lower substrate 100 to bond the upper substrate 200 with the lower substrate 100 of the organic light emitting display device, and the upper substrate 200 and the lower substrate 100 are bonded by hardening the sealant 400 by radiating it with a laser at the second non-display region 510b.

Further, the sensing pads 21 each include a transparent conductive pattern 21a in a region overlapping the sealant 400, a first connection pattern 21b coupled with the sensing line 230, and a second connection pattern 21c electrically coupled with a metal pattern (not shown) on the lower substrate.

In this configuration, the sealant 400 in the region overlapping the sensing pads 21 has seal patterns 402 vertically protruding between the sensing pads 21, as shown in the figure. That is, the second connection patterns 21c are between the seal patterns 402.

Further, the seal patterns 402 are made of the same material as the sealant 400, and as shown in the figure, they may integrally protrude or may be spaced from the sealant (e.g., at predetermined distances).

According to an embodiment, the sealant 400 is radiated by a laser to melt and harden the sealant 400; however, when the sensing pads 21 in the region overlapping the sealant 400 are made of opaque metal, the laser cannot be transmitted, such that the sealant 400 cannot be completely hardened in the region, which may cause a separation of the sealant from the substrates at the region.

Therefore, in an embodiment of the present invention, it is possible to overcome the problem of separation between the sealant and the substrates, by implementing the sensing pads 21 corresponding to the region overlapping the sealant 400, using the transparent conductive patterns 21a, in the sensing pad unit 20.

Further, the sensing pad unit 20 is electrically coupled with a flexible printed circuit board (FPCB) (not shown) attached to an end of the lower substrate 100, and the FPCB is also electrically coupled with a driving IC that drives a plurality of pixels (not shown) in the pixel region of the lower substrate 100, such that an embodiment of the present invention is characterized in that the touch screen panel and the display panel of the flat panel display use one FPCB.

Further, a touch panel driving circuit that drives the touch screen panel may be integrated on the driving IC (not shown), and the driving IC may be directly mounted on a second non-display region of the lower substrate 100 or may be mounted on the FPCB.

In an embodiment of the present invention, in order to electrically couple the sensing pads 21 on the upper substrate 200 with the FPCB attached to the lower substrate 100, the second connection patterns 21c of the sensing pads 21 are electrically coupled with the metal patterns (not shown) on the corresponding substrate by conductive pastes (not shown).

The conductive pastes are filled between the seal patterns 402 described above that function as separating walls. More detailed description is provided below with reference to FIGS. 5 to 7.

The structure of a touch screen panel according to an embodiment of the present invention is described in more detail with reference to FIGS. 1 and 2.

The sensing pattern 220, as shown in FIG. 2, includes a plurality of first sensing cells 220a formed in connection with each other in a first direction (X-axis direction) in each row, first connecting lines 220a1 coupling the first sensing cells 220a in the row direction, second sensing cells 220b formed in connection with each other in a second direction (Y-axis direction) in each column, and second connecting lines 220b1 coupling the second sensing cells 220b in the second direction.

The first sensing cells 220a and the second sensing cells 220b are alternately arranged not to overlap each other while the first connecting lines 220a1 and the second connecting lines 220b1 cross each other. Insulating layers (not shown) are placed between the first connecting lines 220a1 and the second connecting lines 220b1 to ensure stability.

Here, the first sensing cells 220a and the second sensing cells 220b may be made of a transparent material, such as indium-tin-oxide (hereafter, ITO), integrally with the first connecting lines 220a1 and the second connecting lines 220b1, respectively, or may be separately formed and electrically coupled with each other.

For example, the second sensing cells 220b and the second connecting lines 220b1 may be integrally formed in the second direction, and the first sensing cells 220a may be patterned to be independent patterns between the second sensing cells 220b, respectively, and may be coupled in the first direction by the first connecting lines 220a1 above or under the second connecting lines 220b1.

In this configuration, the first connecting lines 220a1 may be electrically coupled in direct contact with the first sensing cells 220a, above or under the first sensing cells 220a, or may be electrically coupled with the first sensing cells 220a through contact holes.

The first connecting lines 220a1 may be made of a transparent electrode material, such as ITO, or an opaque low-resistant material, and the width, etc., can be adjusted to prevent or reduce visualization of the pattern caused by the connecting lines.

The sensing lines 230 are electrically coupled with the first and second sensing cells 220a, 220b in rows and columns to couple the cells to an external driving circuit, such as a position detection circuit, through the sensing pad unit 20.

The sensing lines 230 are at the first non-display region 510a around the display region 500 where an image is displayed, and may be made of a low-resistant material, such as Mo, Ag, Ti, Cu, Al, and Mo/Al/Mo, different from the transparent electrode material used for forming the sensing pattern 220, and various suitable materials.

As described above, the touch screen panel described above is a capacitive type touch screen panel, in which when a contact object, such as a human's hand or a stylus pen contacts the touch screen panel, a change of electrostatic capacitance corresponding to the contact position is transmitted to the driving circuit (not shown) from the sensing patterns 220 through the sensing lines 230 and the sensing pad unit 20. Accordingly, the change in electrostatic capacitance is converted into an electric signal by an X- and Y-input process circuit (not shown), such that the contact position is located.

Further, referring to FIG. 3, in a cross-sectional view of a region (I-I′) of FIG. 1, as described above, the sensing patterns 220 in the display region 500 of the upper substrate include the first sensing cells 220 coupled in a first direction in each row, the first connecting lines 220a1 coupling the first sensing cells 220a in the row direction, the second sensing cells 220b coupled in the column direction in each column, and the second connecting lines 220b1 coupling the second sensing cells 220b in the column direction, in which insulating layers 240 are located at the crossing regions of the first connecting lines 220a1 and the second connecting lines 220b1.

Further, a black matrix 210 is at the non-display region 510 of the upper substrate 200 around the display region 500, as shown in the FIG. 3. The sensing lines 230 electrically coupled with the sensing patterns 220 are in the first non-display region 510a overlapping the black matrix 210, and the sealant 400 for bonding with the lower substrate 100 is in the second non-display region 510b.

The black matrix 210 prevents the patterns, such as the sensing lines, in the non-display region 510, from being visualized and forms a periphery (e.g., the edge) of the display region 500.

Hereinafter, the configuration of the sensing pad unit 20 shown in FIG. 1 is described in more detail.

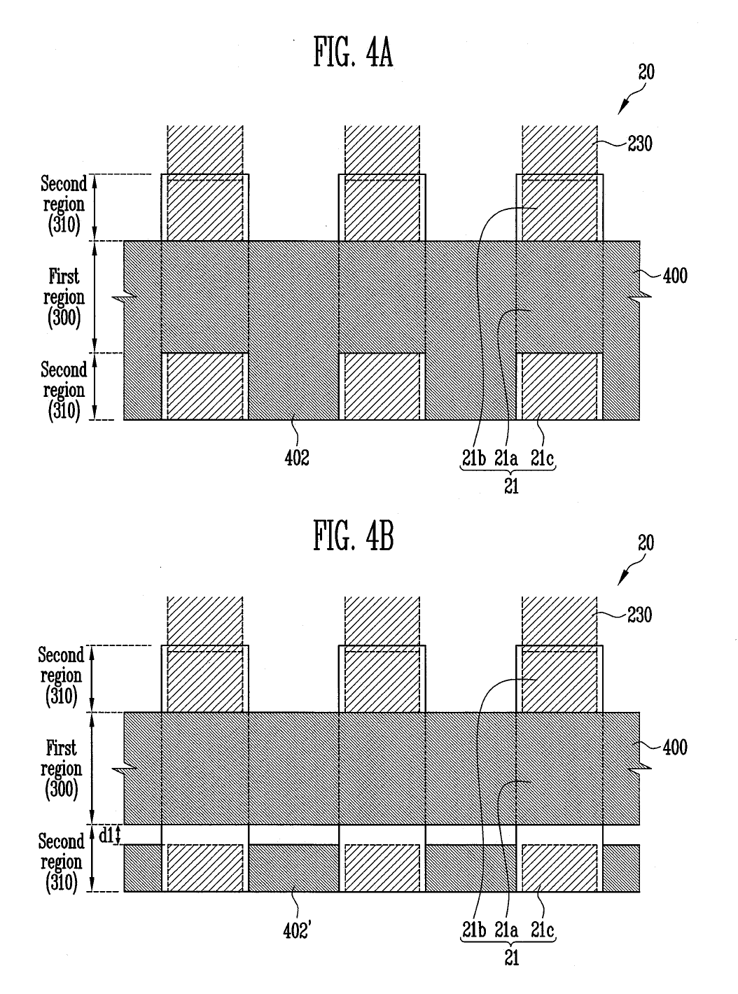

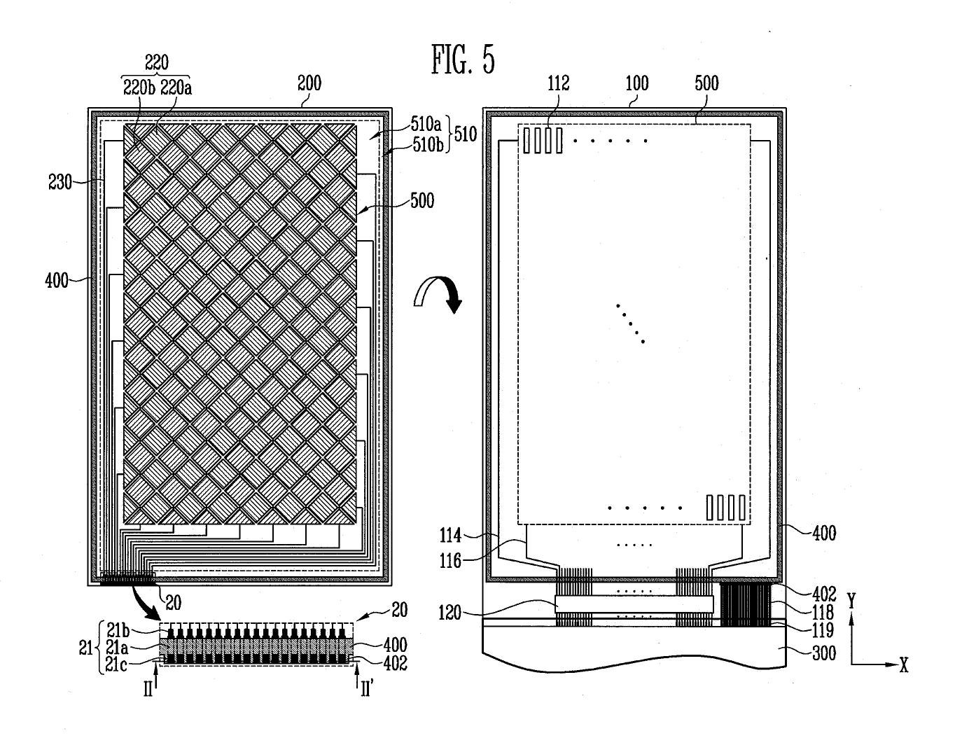

FIGS. 4A and 4B are enlarged plan views of the sensing pad unit 20 according to an embodiment of the present invention.

Referring to FIGS. 4A and 4B, the sensing pad unit 20 according to an embodiment of the present invention includes a plurality of sensing pads 21 that are divided into a first region 300 overlapping the sealant 400 and a second region 310 not overlapping the sealant 400, at the lower portion, and the configurations are different for each region.

The sensing pads 21, as described above with reference to FIG. 1, are at the second non-display region 510b of the upper substrate 200, and the sealant 400 is at a region (e.g., a predetermined region) at the lower portion of the second non-display region 510b.

That is, the sensing pads 21 are divided into the first region 300 overlapping the sealant 400 and the second region 310 not overlapping the sealant 400, and according to the embodiments shown in FIGS. 4A and 4B, opaque metal patterns, such as the sensing lines 230 shown in FIG. 1, are not in the first region 300 overlapping the sealant 400, but the transparent conductive patterns 21a, such as the sensing patterns 220, are used, such that it is possible to remove or reduce the problem of separation between the sealant 400 and the region by transmitting a laser for melting and hardening the sealant 400.

However, low-resistant opaque metal patterns 21b and 21c are under the transparent conductive pattern 21a in the second region 310, which reduces the resistance of the sensing patterns 21 made of high-resistant transparent conductive materials.

In this configuration, the opaque metal patterns include first connecting patterns 21b coupled with the sensing lines 230, respectively, and second connecting patterns 21c electrically coupled with metal patterns (not shown), respectively, on the lower substrate, such that a change in electrostatic capacitance sensed by the sensing patterns 220 is transmitted to the driving circuit (not shown) on the FPCB (not shown).

In this configuration, the sealant 400 in the region overlapping the sensing patterns 21 has seal patterns 402 and 402′ vertically protruding between the sensing patterns 21, as shown in FIGS. 4A and 4B. That is, the second connection patterns 21c are located between the seal patterns 402 and 402′.

Further, the seal patterns 402 and 402′ are made of the same material as the sealant 400, and as shown in FIG. 4A, they may integrally protrude from the sealant 400 or may be spaced (e.g., at predetermined distances) from the sealant 400, as shown in FIG. 4B.

The seal patterns 402 and 402′ function as separating walls between the second connecting patterns 21c, and conductive pastes (not shown) are filled in the regions divided by the seal patterns, such that the second connecting patterns 21c can be electrically coupled with the metal patterns (not shown) on the corresponding lower substrate through the conductive pastes (not shown).

In the embodiment of FIG. 4B, the second connecting patterns 21c in the second region 310 are spaced from the sealant 400 at a distance d1 in order not to overlap the sealant 400, in which the distance d1 is 100 μm according to an embodiment. The distance d1 may be different in other embodiments. This is for ensuring an alignment margin in the manufacturing process and allowing air to be discharged in filling the conductive pastes.

Further, though not shown, the sealant 400 may be moved upward relatively to the second non-display region 510b in the region overlapping the sensing pad unit 20, such that it is possible to ensure the area for the second connecting patterns 21c, without increasing a dead space.

FIG. 5 is a plan view showing an upper substrate and a lower substrate of a flat panel display with an integrated touch screen panel according to an embodiment of the present invention.

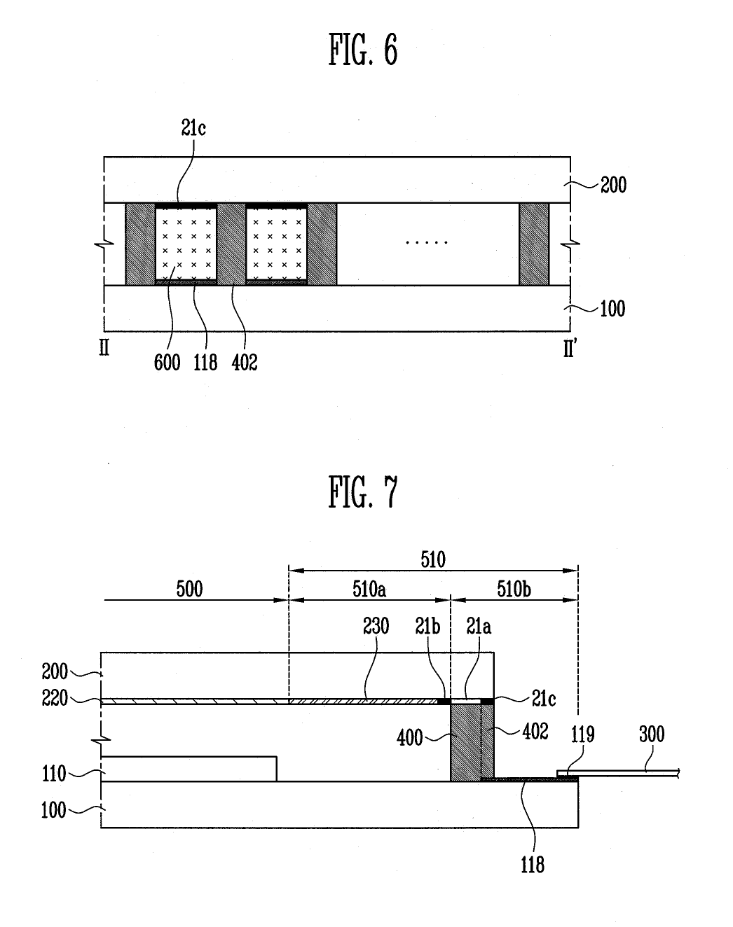

Further, FIG. 6 is a cross-sectional view of a portion (II-II′) of the sensing pad unit 20 of FIG. 5, and FIG. 7 is a cross-sectional view of a portion in the Y-axis including the sensing pad unit 20 of FIG. 5.

However, the components in the display region 500 of the lower substrate 100 of the display panel for displaying an image are not shown in detail in FIG. 5.

An embodiment of the present invention provides a flat panel display with an integrated touch screen panel including sensing patterns 220 and sensing lines 230 on the inner side of an upper substrate 200 sealing a plurality of pixels 112 in the display region 500 of the lower substrate 100.

According to an embodiment of the present invention, the flat panel display is an organic light emitting display device including pixels 112 each having an organic light emitting element (not shown), a thin film transistor (not shown), and a capacitor (not shown), but the embodiments of the present invention are not limited thereto.

In more detail, the flat panel display with an integrated touch screen panel according to an embodiment of the present invention includes a display panel including a lower substrate 100 and an upper substrate 200 facing each other, and sensing patterns 220 and sensing lines 230 on the rear side facing the lower substrate 100 of the upper substrate 200.

In particular, the sensing lines 230 on the bottom of the upper substrate 200 are electrically coupled with metal patterns 118 on the lower substrate 100 through the sensing pads 21, and coupled to a FPCB 300 through the lower substrate 100.

In this configuration, the sensing pads 21 may also be coupled to a driving IC 120 through the metal patterns 118 and the FPCB 300, and the driving IC 120 may include a control circuit or a position detecting circuit for driving the touch screen panel, other than a control unit for driving the display panel.

In more detail, each of the sensing pads 21 includes a first connecting pattern 21b coupled with one of the sensing lines 230 and a second connecting pattern 21c electrically coupled with a transparent conductive pattern 21a in a region overlapping a sealant 400 and metal patterns 118 on the lower substrate 100, and as shown in FIGS. 6 and 7, the second connecting pattern 21c of the sensing pad 21 is coupled with the lower substrate 100 by the metal patterns 118 on the top of the lower substrate 100 through a conductive paste 600.

In this configuration, the conductive paste 600, as shown in FIG. 6, is filled in the regions divided by seal patterns 402.

Further, the seal patterns 402 vertically protrude between the sensing pads 21, from the sealant 400 in the region overlapping the sensing pads 21, such that the second connecting patterns 21c are positioned between the seal patterns 402.

The seal patterns 402 are made of the same material as the sealant 400, and as shown in the figure, they may integrally protrude or may be spaced (e.g., at predetermined distances) from the sealant 400.

Therefore, the touch screen panel and the display panel can share one FPCB 300.

The FPCB 300 supplies a control signal for controlling the display panel by being coupled to one end (e.g., one end with a pad unit including a number of pads) of the lower substrate 100 to be electrically coupled with signal lines of the display panel, that is, scan lines 114 and data lines 116, and may supply a control signal for controlling the touch screen panel by being coupled with the sensing pads 21 through the metal pad 119 and the metal patterns 118 coupled with the metal pad.

In this case, the FPCB 300 is an integration of a flexible printed circuit board for driving a display panel and a flexible printed circuit board for driving a touch screen panel.

Therefore, the manufacturing becomes easy and the unit cost is reduced because the bonding process and testing of the FPCB are simplified, as compared with when FPCBs are separately provided to drive the touch screen panel and the display panel, respectively.

Here, a display region 500 where a plurality of pixels each including a pixel electrode of a liquid crystal display or an organic light emitting element of an organic light emitting display device and a thin film transistor for driving them is formed is defined on the lower substrate 100 of the display panel, and a driving IC 120 for controlling an image displayed in the display region 500 may be mounted at a side of the lower substrate 100.

In this configuration, control circuits for driving the touch panel or a position detecting circuit may be part of the driving IC 120, in the flat panel display with an integrated touch screen panel according to an embodiment of the present invention. In this case, though not shown, the metal patterns 118 coupled with the sensing pads 21 for the touch screen panel may be designed to be directly coupled to the driving IC 120, not through the FPCB 300.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A flat panel display with an integrated touch screen panel, comprising:
an upper substrate and a lower substrate each comprising a display region and first and second non-display regions around the display region;
a plurality of sensing patterns at the display region of the upper substrate facing the lower substrate;
a plurality of sensing lines coupled with the sensing patterns, respectively, at the first non-display region of the upper substrate;
a sensing pad unit comprising a plurality of sensing pads coupled with the sensing lines, at the second non-display region of the upper substrate;
a sealant between the upper substrate and the second non-display region of the lower substrate;
seal patterns protruding from and perpendicular to the sealant in a region overlapping the sensing pads, the seal patterns being between the sensing pads; and
a plurality of metal patterns at the second non-display region of the lower substrate overlapping regions between the seal patterns.

2. The flat panel display with an integrated touch screen panel according to claim 1, wherein each of the sensing pads comprises a first connecting pattern coupled with a corresponding one of the sensing lines, a transparent conductive pattern at a region overlapping the sealant, and a second connecting pattern electrically coupled with a corresponding one of the metal patterns of the lower substrate.

3. The flat panel display with an integrated touch screen panel according to claim 1, wherein the seal patterns comprise a same material as the sealant.

4. The flat panel display with an integrated touch screen panel according to claim 3, wherein the seal patterns protrude integrally from the sealant or are spaced from the sealant.

5. The flat panel display with an integrated touch screen panel according to claim 1, further comprising a conductive paste at each region between the seal patterns.

6. The flat panel display with an integrated touch screen panel according to claim 5, wherein the sensing pads on the upper substrate and the metal patterns on the lower substrate are electrically coupled together, respectively, by the conductive pastes.

7. The flat panel display with an integrated touch screen panel according to claim 1, wherein a flexible printed circuit board electrically coupled with the metal patterns is attached to an end of the second non-display region of the lower substrate.

8. The flat panel display with an integrated touch screen panel according to claim 1, further comprising black matrixes in the first and second non-display regions of the upper substrate to be arranged along a periphery of the display region.

9. The flat panel display with an integrated touch screen panel according to claim 1, wherein the sensing patterns comprise:
first sensing cells coupled to one another in a first direction in each row;
first connecting lines coupling the first sensing cells in the first direction;
second sensing cells coupled to one another in a second direction in each column; and
second connecting lines coupling the second sensing cells in the second direction.

10. The flat panel display with an integrated touch screen panel according to claim 9, wherein the second sensing cells are integrally formed with the second connecting lines.

11. The flat panel display with an integrated touch screen panel according to claim 9, further comprising insulating layers at crossing regions of the first connecting lines and the second connecting lines.

12. The flat panel display with an integrated touch screen panel according to claim 1, further comprising a plurality of pixels at the display region of the lower substrate, and a plurality of signal lines electrically coupling the pixels with pads at the second non-display region at the first non-display region of the lower substrate.

13. The flat panel display with an integrated touch screen panel according to claim 12, wherein the signal lines comprise a plurality of scan lines and data lines.
